(19) United States
(12) Patent Application Publication
(10) Pub. No.: US 2004/0030807 A1
(43) Pub. Date: Feb. 12, 2004

(54) Input device in a motor vehicle and a method of input of charactors from a character set

(76) Inventors: Olaf Wessler, Stuttgart (DE); Christian Schroder, Bad Salzuflen (DE)

Correspondence Address: Morriss O'Bryant Compagni, Suite 700, 136 South Main Street, Salt Lake City, UT, 84101, US

(21) Appl. No.: 10/333,886

(22) PCT Filed: Jul. 25, 2001
(86) PCT No.: PCT/EP01/08608

(30) Foreign Application Priority Data
Jul. 26, 2000 (DE) 100 36 421.7

(51) Int. Cl. G06F 3/00

(52) U.S. Cl. 710/1

(57) ABSTRACT

An input device in a vehicle and method of implementing it are proposed. The input device (15) comprises a scrolling device (17) and at least one pushbutton (21A; 21B; 21C) for selection and input of characters from a character set (27). At least a portion of the character set (27) is displayed by rows and by columns on a display screen (23). The input of a character is performed by means of the scrolling device (17) which preselects a portion of a column or an entire column and by means of at least one pushbutton (21A; 21B; 21C) by means of which a character is selected from a row of the preselected column.

### DESCRIPTION

This invention relates to an input device in a motor vehicle, having at least one scrolling device and at least one pushbutton for selection and input of characters from a character set as well as a display screen according to claim 1 and a method of input of characters from a character set into an input device ac cording to claim 47.

There are known input devices having a scrolling device, at least one pushbutton and a display, in which information, e.g., names and/or telephone numbers or the like is displayed, the number of which is so great that they cannot all be displayed on the display at the same time. With the help of the scrolling device, the information can be scrolled through on the display row by row. One disadvantage of this is that the search for certain information takes a relatively long time.

The object of this invention is to create an input device and a method of the type defined in the preamble, which can be implemented with it without this disadvantage.

To achieve this object, an input device having the features of claim 1 is proposed.

The input device includes a display, at least one scrolling device and at least one pushbutton for selection and input of characters from a character set. At least part of the character set is displayed row by row and column by column on a display, and input of a character is performed by means of the scrolling device which preselects at least apportion of a column and by means of the at least one pushbutton by means of which a character is selected from a row of the previously selected column.

In conjunction with the present invention, the term “character” is understood to include both letters, numbers and special characters such as the character sequence “www.” or “—” or the like, but also menu fields or functions of devices, in particular of the motor vehicle, such as the radio, telephone, air conditioning system, onboard computer, navigation system and the like. In other words, by means of the input device, it may optionally also be possible to influence devices in the vehicle, e.g., to change the passenger compartment temperature selected for the air conditioning system or to dial a name or number from a telephone list and optionally make a phone call by means of a telephone. It is clear that the input of characters is understood to refer not only to input into the input device but also execution of a certain function of a device in the vehicle or the input device itself or retrieving information.

In a preferred embodiment, at least some of the components of the input device are arranged on at least one operating element of the motor vehicle. The operating element may be, for example, a steering element of a steering device, in which case the steering element is a steering wheel or a control lever, in particular a joystick. To be able to influence the direction of driving of the vehicle, it is readily also possible to use two of these control levers. The operating element may also be a gearshift element of a gear change mechanism. If the vehicle has a gearshift mechanism, the Shift element is preferably designed as a gearshift lever or a stick shift, which can usually be used in the direction of travel, across the direction of travel and opposite the direction of travel. If the vehicle has an automatic transmission, the gearshift element may be formed by a handle having a cylindrical section, which is gripped by the entire hand. This handle is usually moved only in the direction of travel and in the opposite direction to set a different driving step, i.e., function step of the automatic transmission. The operating element may also be a function lever, e.g., a manual brake lever, a windshield wiper lever, a flashing light lever or a lever for accelerating or decelerating the vehicle. It is of course also possible for the function lever to serve no other purpose than to accommodate at least one of the components of the input device, e.g., the scrolling device and optionally at least one pushbutton. Finally, the operating element may also be formed by a touchpad. Inn this case the scrolling device is implemented by the fact that a stylus or preferably a finger of a hand moves on the touchpad and by pressure on the touchpad at a certain location, a character displayed there is selected. A separate pushbutton may be omitted here entirely, if necessary. It is clear that it is readily possible for the individual components of the input device to also be distributed among multiple operating elements of the vehicle. Thus, for example, the scrolling device may be situated on the steering element, and the at least one pushbutton may be situated on a function lever. Other arrangement variations are also possible.

In an especially, preferred exemplary embodiment of the input device, the scrolling device is mounted on the operating element in such a way that with conventional handling of the operating element, the thumb of the hand gripping the operating element rests on the scrolling device. This permits ergonomic handling of the input device.

According to a refinement of this invention, it is provided that the at least one pushbutton be arranged on the operating element in such a way that with conventional handling of the operating element, one finger of the hand gripping the operating element rests on it, preferably in an ergonomic position. The pushbutton is thus not arranged at a location where it is difficult to reach, but instead on reaching the operating element in the conventional manner provided for it, the corresponding finger will automatically rest on the pushbutton.

In an especially preferred exemplary embodiment of the input device, the scrolling device and the at least one pushbutton are arranged on the operating element in such a way that with one-handed operation of the input device, the scrolling can be operated with the thumb and the at least one pushbutton can be operated with at least one of the other fingers of the same hand.

It is especially advantageous if the operating element is the at least one steering element for influencing the direction of travel of the vehicle, because for operation of the input device, the driver need not remove his hands from the steering element, but instead the input device can be operated easily, namely preferably with one hand, which is possible while driving.

In a preferred exemplary embodiment of the input device, the steering wheel comprises a steering wheel rim and a steering wheel hub which are joined together by means of a supporting structure, preferably formed by a spoke arrangement. The scrolling device is arranged at a location on the steering wheel where the thumb of one hand rests when gripping the steering wheel in the usual manner. Depending on how the supporting structure and the steering wheel hub are designed, each type of steering wheel can be handled as usual in at least one way. For example, the scrolling device may be arranged on the steering wheel rim, preferably in the area of the inside, with the arrangement of the scrolling device in the circumferential direction of the steering wheel rim preferably being selected so that when the vehicle is driving straight ahead, the scrolling device is arranged approximately between the 2 o'clock position and the 4 o'clock position. In this case, the scrolling device is operated with the thumb of the right hand. The scrolling device may also be arranged, for example, on the supporting structure or on the steering wheel hub if its design, in particular the shape and size of the steering wheel make this possible. It is readily also possible to arrange the scrolling device on the steering wheel so that it can be operated with the thumb of the left hand while the hand is gripping the steering wheel. It is of course also possible to design at least the scrolling device and optionally also the at least one pushbutton in duplicate in mirror image symmetry for right-handed and left-handed operation.

To also permit ergonomic handling of the at least one pushbutton by means of which a character is selected from a row of the preselected column of the set of characters, this (the row or column) is preferably arranged on the back side of the steering wheel rim. The button is preferably operated with the index finger, the middle finger or the ring finger of the hand, while the thumb of this hand preferably operates the scrolling device. It is of course also possible for the scrolling device to be operated, for example, with the right hand and for at least one button to be operated with the left hand. As an alternative, at least one button may also be arranged on the inside of the steering wheel rim.

According to a refinement of this invention, it is provided that a plurality of pushbuttons, preferably three, are arranged one above the other on the operating element, i.e., on the steering wheel, in particular the steering wheel rim, for example. In this case, an upper pushbutton is preferably operated with the index finger, a middle pushbutton is preferably operated with the middle finger and a lower pushbutton is preferably operated with the ring finger. Thus, the person operating the buttons need not switch from the scrolling device to the buttons, but instead he can leave his finger, e.g., his thumb, which is resting on the scrolling device, in that position, while operating the pushbuttons with at least one of the other fingers on the same hand.

In another exemplary embodiment of the input device, at least some of the components of the input device are arranged on a flat side of an automotive component. Thus, for example, the scrolling device and/or the pushbutton may be arranged on a shelf, an armrest or the like of the vehicle, preferably in a location where the driver's hand can be placed or supported in an ergonomic position, preferably with the thumb of the hand resting on the scrolling device and a finger of the same hand resting on the at least one pushbutton.

In addition, in a preferred exemplary embodiment of the input device only a portion of the character set is shown on the display. In this case, the character set may be shifted on the display by means of the scrolling device. According to a second exemplary embodiment, the complete character set is Shown on the display, which can entail advantages in the search for a certain column, because all the characters can be discerned at one glance without having to operate the scrolling device so do so.

In an advantageous exemplary embodiment of the display device, the character set fills up the entire display. This permits a large representation of the characters of the character set represented in a matrix having several columns and at least one row. The recognizability of the characters and this the operating convenience of the device are improved.

In addition, in another preferred embodiment of the input device, only a detail of the character set is shown in the display, which can be shifted over the entire character set by operation of the scrolling device having preferably at least one scrolling wheel, thus permitting access to all characters.

According to another exemplary embodiment, the character set can be scrolled through continuously, with the beginning and end being joined. Thus, the character set is so large that only sections thereof can be displayed on the display screen. To select a desired column, it is sufficient to shift the character set in only one direction by means of the scrolling device until the desired column is at a desired location on the display screen. A complicated scrolling back and forth to search for a certain character, i.e., a certain column is not necessary here.

In another exemplary embodiment, the character set is displayed at the lower edge of the display. This offers the possibility of displaying in the part of the display above it the information to be retrieved or the information to be stored in the device, while a character or a sequence of characters from the character set or a certain function, e.g., a menu selection, is input into the device.

According to another embodiment, the character set may be enlarged or reduced according to a zoom function. This makes it possible for the person operating the device to individually adjust the size of the characters to his needs. The display of the character set in the display may be such that the character set appears in “normal” display mode at the lower edge of the display and, if desired, it appears enlarged or reduced by the zoom function. Zooming is preferably continuous. Of course it is also readily possible to implement a graduated zoom.

In a preferred exemplary embodiment of the input device, the character is preferably displayed in several rows, preferably three rows. The character set having a number of columns may also have only one row, but it has also been found that a character set having multiple rows offers advantages in rapid selection and input of a character from the character set. Thus, the character set matrix may have two rows or more than three rows, e.g., four or five rows.

In a preferred embodiment, a pushbutton is assigned to each row of the character set matrix by means of which a character is selected from the column preselected by means of the scrolling device. It is advantageous in this embodiment that after a desired column has been selected by means of the scrolling device, a very rapid selection of the character in the corresponding row can be made by depressing the corresponding pushbutton assigned to it.

In a preferred exemplary embodiment of the input device, the column of the character set matrix selected with the scrolling device is displayed with a visual emphasis by at least one bar, which is also frequently referred to as a cursor. The bar preferably consists of boxes arranged one above the other and/or it is formed by such boxes. It is advantageous here if the number of boxes of the bar corresponds to the number of rows of the character matrix. For selection of a desired character from the character set, the column having the character must thus coincide with the bar or cursor. Only then can the character be selected by depressing the pushbutton.

In one embodiment of the input device, by depressing on the corresponding pushbutton, the selected character is visually emphasized in the corresponding box of the bar. The boxes of the bar thus initially all have the same color and/or the same hue or they are transparent and by operation of the corresponding pushbutton the box containing the selected character undergoes a change in color.

The bar may be in a fixed position in the center of the display, i.e., it may be arranged in a fixed position, with the character set being moved by means of the scrolling device. To select a certain character, thus at first the column within which the character is located must be moved into the bar, and then the selection of the character in the corresponding row and/or box must be made by the at least one pushbutton. According to another variant of the embodiment, the bar is moved over the fixed character set by means of the scrolling device. Thus in this case the character set stands still while the bar is moved over the columns of the character set matrix. If the character set is not displayed completely in the display but instead only sections thereof are displayed at one time, it is provided according to an advantageous variant that when the previously moving bar reaches the edge of the display, the scrolling function switches to the character set which is thus moved instead of the bar on operation of the scrolling device.

The character set preferably has at least one alphabet part. The character set may also have special characters, e.g., plus signs, currency symbols, numbers, etc. Preferably the character set is designed in a form in which the most commonly used special characters are connected to the alphabet part on the right and left and less common special characters are imaged at a greater distance from the alphabet part.

In a preferred embodiment, the character set is designed in a form in which the sequence of letters in each column in the alphabet part runs from top to bottom, the first letter in the alphabet being arranged at the upper left. In other words, assuming the alphabet is in German, then the letter “A” will a pear in the top box of a first column of the alphabet part, the letter “B” will appear in the box below that in the same column and, if it is a three-row character set matrix, the letter “C” will appear in the bottom box in the first column while the letter “D” according to the sequence of rows described above, will appear in the top box in the second column of the alphabet part.

To permit a rapid orientation within the character set, it is provided in an advantageous embodiment that an orientation bar representing symbolically the total length of the character set on which a movable mark indicates the instantaneous position of the alphabet part in the character set is imaged on the display in parallel with the character set.

In a preferred embodiment of the input device, the character set is shifted horizontally by means of the scrolling device until the desired character appears in the centrally positioned bar, i.e., arranged in a fixed position, with the desired character appearing as one of several characters of the character set matrix arranged one above the other.

In an especially advantageous exemplary embodiment of the input device, the scrolling device has a scrolling wheel. This permits reliable operation with one finger of one hand, with the scrolling wheel preferably being mounted on the operating element or on some other component of the vehicle, so that the thumb can be used in an ergonomic position for rotating the wheel. The scrolling wheel, which preferably has a knurled border, permits a continuous or stepped shifting of the bar and/or the character matrix on the display in one direction or in the opposite direction. Due to the direction of movement defined and selected by the scrolling wheel, selection of the character from the character set is simplified in comparison with known operating elements such as a track ball or a mouse.

According to another refinement of this invention, the scrolling wheel is designed as a pushbutton. For this purpose, a shiftable axis for rotationally movable mounting of the scrolling wheel is provided, preferably having at least one pressure sensor in the area of the suspension of the axle. As an alternative, the pressure sensor may also be arranged in the area of the outside surface of the scrolling wheel. The scrolling wheel which has been provided with the pressure sensor and/or cooperates with it thus has a double function, namely for selecting at least one part of a column of the character set matrix and secondly for selecting the character from a row of the preselected column. It is advantageous here that it is possible to eliminate a separate pushbutton for selection of the character from the preselected column, if necessary, and the preselection of the column and the selection of the desired character from this column may be performed with the same finger of the same hand while at the same time this hand is holding the device.

In an advantageous exemplary embodiment, the scrolling wheel is interchangeable and may be designed in different versions to permit different transmission ratios for the scrolling function.

Alternatively or in addition to the at least one scrolling wheel, the scrolling device may have one sensor strip, at least one touchpad and/or at least one toggle button. It is important that one finger of the hand is sufficient for scrolling through the bar and/or the character set matrix. The sensor strip and the touchpad do not have any moving parts for scrolling. For scrolling it is sufficient to merely guide onto finger over the sensor strip and/or the touchpad. In an exemplary embodiment, at least two sensor strips are provided, a first sensor strip being used exclusively for scrolling in a first direction of movement and the second sensor strip being used for scrolling in a second direction of movement, preferably orthogonal to the first direction of movement. It is thus possible to scroll through the character set or the bar with the first sensor strip. After preselection of a certain column by means of a second sensor strip, a row in the preselected column is selected.

In addition, in a preferred exemplary embodiment the pushbuttons and/or the extra pushbuttons are designed as sensor buttons which are not shifted on operation but instead respond to pressure impact so that they are subject to practically no human wear during operation of the input device.

In addition, an exemplary embodiment of the input device, which is characterized in that the display and a selection and input unit comprising at least the scrolling device are situated in spatially separate areas. While the selection and input unit is on an operating element of the vehicle, for example, the display may be mounted on a console or a dashboard of the vehicle, for example. Furthermore, it is possible for the display to be integrated into the windshield and/or to be imaged on the windshield, in which case the arrangement is selected with respect to the seat position of the driver so that the display appears approximately at the driver's eye level and optionally another display appears in the direct line of vision of the passenger. Of course it is readily possible for the display to be provided on the operating element of the vehicle, i.e., on the steering wheel, for example, in particular the steering wheel hub. It is also conceivable for several displays to be provided at least for the driver of the vehicle, in which case they may be arranged as described above, for example. Finally, the display may be designed as a heads-up display (HUD).

Other advantageous embodiments of the input device are derived from the other subclaims.

To solve this problem, furthermore a method having the features of claim 47 is proposed. It is used for input of characters from a character set into an input device arranged in a motor vehicle. The input device includes at least one scrolling device and at least one pushbutton. At least a portion of the character set is displayed on a display screen by row and by column. This method is characterized in that input of a character is performed by using the scrolling device which preselects at least part of a column and by using the at least one pushbutton by means of which a character is selected from a row of the preselected column.

This invention is explained in greater detail below on the basis of the drawing, showing:

FIG. 1 an exemplary embodiment of an input device arranged on an operating element of a vehicle for input of characters of a character set;

FIG. 2 a detail of the operating element shown in FIG. 1, as seen in the area of a display screen on a greatly enlarged scale;

FIG. 3 an exemplary embodiment of the character set;

FIG. 4 a perspective view of the character set shown in FIG. 2, the ends of which are joined together to form a virtual continuous strip;

FIG. 5 a detail of a character set displayed on a display screen of the device, shown in the basic position; and

FIG. 6 a detail of the display screen, wherein the character set is moved out of its basic position by scrolling.

FIG. 1 shows an exemplary embodiment of an operating element 1 in a vehicle (not shown), e.g., a motor vehicle. Operating element 1 here is a steering element 3 of a steering mechanism of the vehicle, designed here as steering wheel 5. This includes a steering wheel rim 7 and a steering wheel hub 9, which are joined together by means of a supporting structure 11, which is formed here (in this exemplary embodiment) by a spoke arrangement having a total of four spokes 13A, 13B. 13C and 13D.

An input device 15 comprising a scrolling device 17 having a scrolling wheel 19, pushbuttons 21A, 21B and 21C for selection and input of characters from a character set and a display screen 23 is arranged on steering wheel 5.

In the exemplary embodiment illustrated in FIG. 1, the scrolling wheel 19 is on the upper right spoke 13A at a slight distance from the inside 25 of steering wheel rim 7. The arrangement of scrolling wheel 19 is selected here so that with conventional handling of steering wheel 5, in particular when driving the vehicle straight ahead, the thumb of the right hand rests on scrolling wheel 19 and/or is in the immediate vicinity thereof. The pushbuttons 21A through 21C are located on the rear side of the steering wheel rim 7 according to the illustration in FIG. 1 and therefore are indicated only with a dotted line. The arrangement of the pushbuttons 21A through 21C is selected so that when gripping the steering wheel rim 7, the thumb of the hand rests on scrolling wheel 9 with the index finger on pushbutton 21A, the middle finger on pushbutton 21B and the ring finger on pushbutton 21C. With such an arrangement of scrolling device 17 and pushbuttons 21A through 21C, ergonomic one-handed operation of input device 15 and text input into same are possible.

FIG. 2 shows on a greatly enlarged scale a detail of the steering wheel hub 9 of the exemplary embodiment illustrated in FIG. 1 in the area of display screen 23. In the lower area of display screen 23 is shown a part of a character set 27 including a number of columns and, in this exemplary embodiment, a total of three rows. The total character set 27 is so large because of the relatively large so ale, which is easier to recognize in that it cannot be displayed completely on display screen 24. In other words, the character set 27 extends beyond the boundaries of display screen 23, the beginning and end being joined together to form a continuous strip 29 (FIG. 4). This “continuous strip 29” is a virtual strip, i.e., not a three-dimensional strip. Thus, the term “continuous” or “endless” in this sense is understood to mean that, e.g., in the character set 27 shown in FIG. 3, which is also illustrated here, on reaching the last column on the right end of character set 27, for example, the first column on the left side appears on the display screen when continuing to scroll in the same direction. The display of the continuous strip 29 on the display screen may be three-dimensional, for example, i.e., the continuous strip 29 has a curvature in the edge areas of the display, e.g., as indicated in FIG. 4, such that the impression of an actual strip is achieved visually.

The character set 27 can be moved virtually as a whole with the help of the scrolling wheel 19 on the display screen until the desired character appears in a bar 31 imaged centrally on the display screen 23; this bar is also referred to as a cursor. Beneath the character set 27 there is an orientation bar 33 along the transverse side of the display screen 23, representing symbolically the total length of character set 27 on which a mark 35, which moves with character set 27, indicates the instantaneous position of an alphabet part 37 in character set 27. By depressing one of the three pushbuttons 21A, 21B, 21C, it is now possible to enter a character into input device 15. Pushbutton 21A is assigned to the top character within bar 31, pushbutton 21B is assigned to the central character within bar 31 and pushbutton 21C is assigned to the lower character within bar 31. The character input by depressing the pushbutton then appears in the upper area of display screen 21., i.e., above character set 27, in an application which is running there but will not be described in greater detail here.

As shown in FIG. 2, only one section 43 of the character set is displayed on display screen 23, which can be shifted over the entire character set 27 by operation of scrolling device 17 and thus allows access to all the characters.

To facilitate the input, the character set 27 is composed of multiple blocks 39, each of which contains characters in a category. The arrangement of blocks 39 in character set 27 corresponds to the frequency with which the characters are used. Thus, for example, the alphabet part 37, which contains in ten columns all the characters of the alphabet including the umlauts [ä, ü, etc.] and the “β” [ss] Is arranged centrally in character set 27 and marks the middle of it. Characters that are needed only rarely are situated at a distance from this center accordingly. Thus, on the whole, the character set 27 here is composed of six blocks 39 with a total of 35 columns. For character input in this exemplary embodiment, the character set 27 is displayed on display screen 23, so that the alphabet plus three punctuation marks, namely the period, comma and question mark, are displaced for a total of eleven columns. The bar 31, which is imaged centrally on display screen 23, thus appears above the sixth column having the characters P, Q, R, and t emphasizes this column by outlining it in the form of three boxes 41A, 41B and 41C arranged one above the other. Due to such an arrangement of the character set 27, an especially effective and rapid text input is possible.

The character set 27 illustrated in FIG. 2 through [sic] represents only one advantageous exemplary embodiment. With another embodiment of character set 27, it may of course also have less than six blocks or, if necessary, even more than six blocks. The number of columns may vary, i.e., it may easily be greater than or less than 35. The same thing is also true of the number of rows in the character set matrix 27, i.e., it is readily also possible for the character set 27 in another exemplary embodiment not shown in these figures to have less than three rows, e.g., only one row or two rows or more than three rows, e.g., four or five rows.

It should be recalled that the scrolling device 15 in deviation from the exemplary embodiment of the steering wheel 5 illustrated in FIG. 1 may also be arranged on the steering wheel rim 7, and the pushbuttons 21A through 21C may also be arranged on the front side of steering wheel rim 7 or on the side thereof. This means that the arrangement of the scrolling device 17 is not limited to the spoke 13A but instead it may also be arranged, for example, on spoke 13D or in another location on steering wheel 5. The same thing is also true with respect to the arrangement of pushbuttons 21A through 21C. The arrangement of the scrolling device 17 and the pushbuttons within the vehicle on the operating element, for example, is preferably always selected so that they can be operated in an ergonomic manner. In the conventional handling of the operating element in particular, the fingers of the hand gripping the operating element come to rest on the manually operated function elements of the input device 5.

It is clear from all of this that the input device 15 may also be arranged on a joystick, a gearshift lever or some other function lever of the vehicle, and it is also preferably true here that the arrangement of the scrolling device and the pushbuttons is selected so that with the conventional handling of these operating elements, the finger intended for this operation rests on the scrolling device and/or on he at least one pushbutton.

To solve this problem, furthermore a method having the features of claim 47 is proposed. It is used for input of characters from a character set into an input device arranged in a motor vehicle. The input device includes at least one scrolling device and at least one pushbutton. At least a portion of the character set is displayed on a display screen by row and by column. This method is characterized in that input of a character is performed by using the scrolling device which preselects at least part of a column and by using the at least one pushbutton by means of which a character is selected from a row of the preselected column.

### BRIEF DESCRIPTION OF THE DRAWINGS

This invention is explained in greater detail below on the basis of the drawing, showing:

FIG. 1 shows an exemplary embodiment of an input device arranged on an operating element of a vehicle for input of characters of a character set;

FIG. 2 shows a detail of the operating element shown in FIG. 1, as seen in the area of a display screen on a greatly enlarged scale;

FIG. 3 shows an exemplary embodiment of the character set;

FIG. 4 shows a perspective view of the character set shown in FIG. 2, the ends of which are joined together to form a virtual continuous strip;

FIG. 5 shows a detail of a character set displayed on a display screen of the device, shown in the basic position; and

FIG. 6 shows a detail of the display screen, wherein the character set is moved out of its basic position by scrolling.

### DETAILED DESCRIPTION

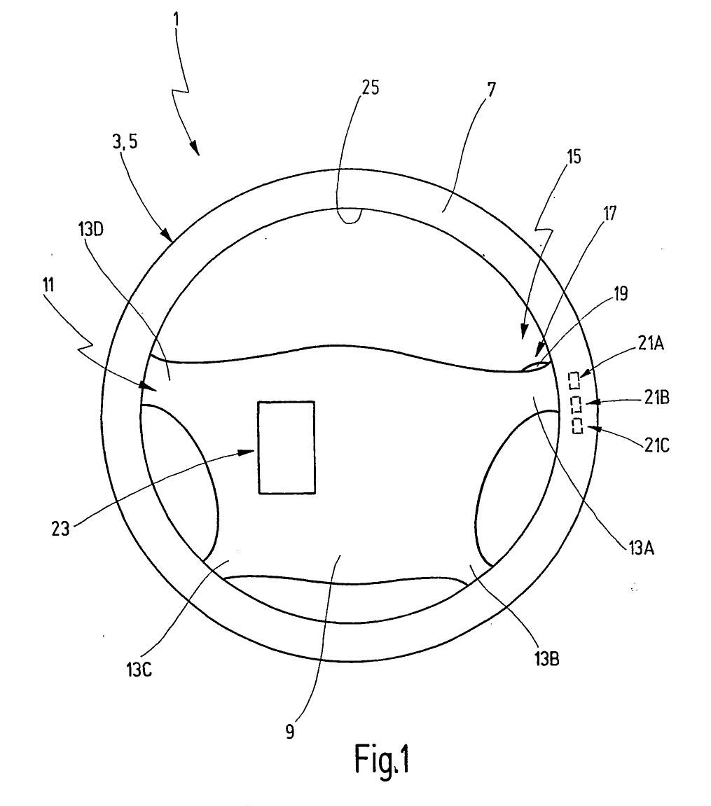

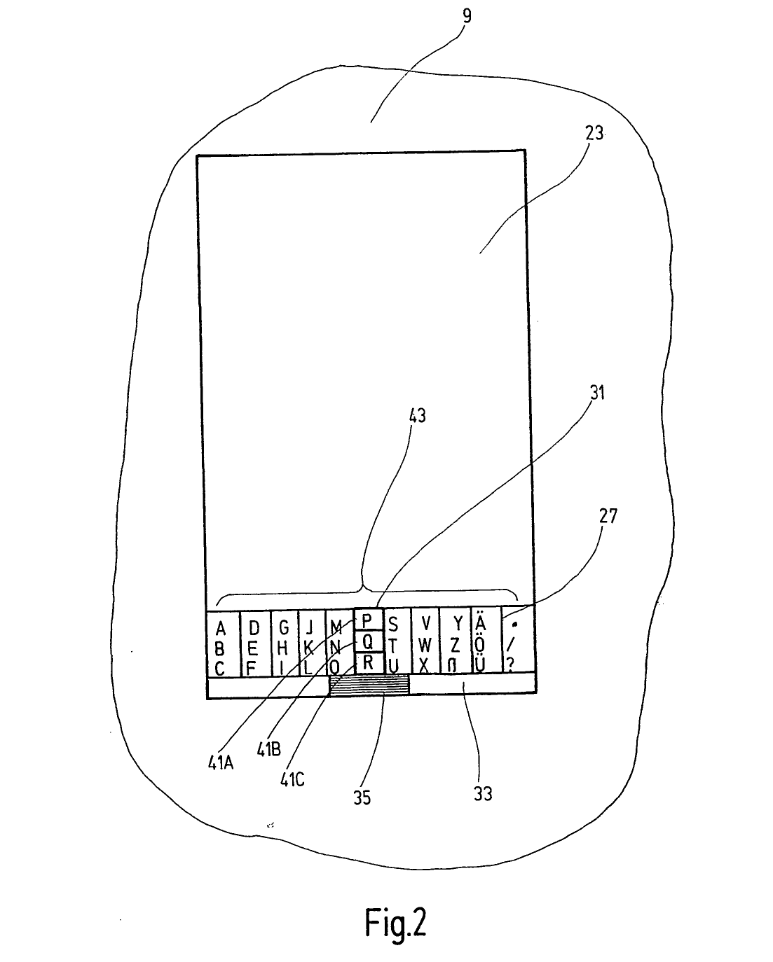

FIG. 1 shows an exemplary embodiment of an operating element 1 in a vehicle (not shown), e.g., a motor vehicle. Operating element 1 here is a steering element 3 of a steering mechanism of the vehicle, designed here as steering wheel 5. This includes a steering wheel rim 7 and a steering wheel hub 9, which are joined together by means of a supporting structure 11, which is formed here (in this exemplary embodiment) by a spoke arrangement having a total of four spokes 13A, 13B, 13C and 13D.

An input device 15 comprising a scrolling device 17 having a scrolling wheel 19, pushbuttons 21A, 21B and 21C for selection and input of characters from a character set and a display screen 23 is arranged on steering wheel 5.

In the exemplary embodiment illustrated in FIG. 1, the scrolling wheel 19 is on the upper right spoke 13A at a slight distance from the inside 25 of steering wheel rim 7. The arrangement of scrolling wheel 19 is selected here so that with conventional handling of steering wheel 5, in particular when driving the vehicle straight ahead, the thumb of the right hand rests on scrolling wheel 19 and/or is in the immediate vicinity thereof. The pushbuttons 21A through 21C are located on the rear side of the steering wheel rim 7 according to the illustration in FIG. 1 and therefore are indicated only with a dotted line. The arrangement of the pushbuttons 21A through 21C is selected so that when gripping the steering wheel rim 7, the thumb of the hand rests on scrolling wheel 19 with the index finger on pushbutton 21A, the middle finger on pushbutton 21B and the ring finger on pushbutton 21C. With such an arrangement of scrolling device

1. An input device (15) in a motor vehicle having at least one scrolling device (17) and at least one pushbutton (21A, 21B, 21C) for selection and input of characters from a character set (27), wherein at least a portion of the character set (27) is displayed on a display screen (23) by rows and by columns, and the input of a character is performed by means of the scrolling device (17), which preselects a portion of a column or an entire column and by means of the at least one pushbutton (21A, 21B, 21C) by means of which a character is selected from a row of the previously selected column.

2. The input device according to claim 1, characterized in that at least some of the components of the input device (15) are arranged on at least one operating element (1) of the vehicle.

3. The input device according to one of the preceding claims, characterized in that the operating element (1) is a steering element (3) of a steering device, a gearshift element of a gearshift mechanism, a function lever and/or a touchpad.

4. The input device according to one of the preceding claims, characterized in that the scrolling device (17) is arranged on the operating element (1) so that with conventional handling of the operating element (1), the thumb of the hand gripping the operating element (1) rests on the scrolling device (17).

5. The input device according to one of the preceding claims, characterized in that the at least one pushbutton (21A; 21B; 21C) is arranged on the operating element (1) so that with conventional handling of the operating element (1) a finger of the hand gripping the operating element (1) rests on it, preferably in an ergonomic position.

6. The input device according to one of the preceding claims, characterized in that the scrolling device (17) and the at least one pushbutton (21A, 21B, 21C) are arranged on the operating element (1) so that when the input device (15) is operated with one hand, the scrolling device (17) can by operated with the thumb, and the at least one pushbutton (21A; 21B; 21C) can be operated with it least one of the other fingers of the same hand.

7. The input device according to one of the preceding claims, characterized in that the steering element (3) is a steering wheel (5), a control horn [sic] or a control lever, in particular a joystick.

8. The input device according to one of the preceding claims, characterized in that the steering wheel (5) comprises a steering wheel rim (7) and a steering wheel hub (9) joined together by means of a supporting (11), and the scrolling device (17) is arranged in a location on the steering wheel (5) where the thumb of one hand rests when gripping the steering wheel (5).

9. The input device according to one of the preceding claims, characterized in that the at least one pushbutton (21A; 21B; 21C) is arranged on the inside (25) of the steering wheel rim (9) [sic].

10. The input device according to one of the preceding claims, characterized in that the at least one pushbutton (21A; 21B; 21C) is arranged on the rear side of the steering wheel rim (9) [sic].

11. The input device according to one of the preceding claims, characterized in that the number of pushbuttons is the same as the number of rows in the character set (27).

12. The input device according to one of the preceding claims, characterized in that several pushbuttons, preferably three pushbuttons (21A, 21B, 21C) are provided and are arranged one above the other.

13. The input device according to one of the preceding claims, characterized in that the input device (15) has other extra pushbuttons, preferably arranged on the operating element (1) by means of which certain characters (optionally other characters not displayed in the character set (27) for example, a blank space or functions, can be input directly.

14. The input device according to one of the preceding claims, characterized in that at least some of the components of the input device (15) are arranged on a flat side of a vehicle component.

15. The input device according to one of the preceding claims, characterized in that the display screen (23) and the manually operable function elements of the input device (15), in particular the scrolling device (17) and the at least one pushbutton (21A; 21B; 21C), are arranged at separate locations in space.

16. The input device according to one of the preceding claims, characterized in that the complete character set (27) can be displayed on the display screen (23).

17. The input device according to one of the preceding claims, characterized in that the character set (27) fills up the entire display screen (23).

18. The input device according to one of the preceding claims, characterized in that it is possible to zoom on the character set (27), preferably continuously.

19. The input device according to one of the preceding claims, characterized in that the character set (27) is represented in several rows, preferably in three rows.

20. The input device according to one of the preceding claims, characterized in that each row is assigned a pushbutton (21A; 21B; 21C).

21. The input device according to one of the preceding claims, characterized in that only a portion (43) of the character set (27) is displayed at one time on the display screen (23) and can be shifted over the entire character set (27) by operating the scrolling device (17), thus permitting access to all characters.

22. The input device according to one of the preceding claims, characterized in that the character set (27) is displayed on the lower edge of the display screen (23).

23. The input device according to one of the preceding claims, characterized in that the character set (27) can be scrolled through continuously, with the beginning and end being joined together.

24. The input device according to one of the preceding claims, characterized in that the column of the character set matrix (27) selected by using the scrolling device (17) is displayed with a visual emphasis by means of at least one straight bar (31).

25. The input device according to one of the preceding claims, characterized in that the character set (27) is shifted by means of the scrolling device (17), preferably in parallel with the upper and/or lower edge of the display or the left and/or right side edges of the display, until the desired character appears in the centrally fixed bar (31) as one of several characters of the character set matrix (27) arranged one above the other.

26. The input device according to one of the preceding claims, characterized in that the bar (31) consists of and/or is formed by boxes (41A, 41B, 41C) arranged one above the other.

27. The input device according to one of the preceding claims, characterized in that the number of boxes (41A, 41B, 41C) of the bar (31) corresponds to the number of rows of the character set matrix (27).

28. The input device according to one of the preceding claims, characterized in that the character selected by depressing the pushbutton is emphasized visually in the corresponding box (41A, 41B, 41C) of the bar (31).

29. The inputs device according to one of the preceding claims, characterized in that the bar (31) is fixed in the center of the display (23), and the character set (27) is moved by means of the scrolling device (17).

30. The input device according to one of the preceding claims, characterized in that the bar (31) is moved over the fixed character set (3) by the scrolling device (17).

31. The input device according to one of the preceding claims, characterized in that when the previously moving bar (31) encounters the edge of the display screen (23), the scrolling function switches to the character set (27) which is thus being moved instead of the bar (31) on operation of the scrolling device.

32. The input device according to one of the preceding claims, characterized in that the character set (27) comprises at least one alphabet part (37) and special characters, and the character set (27) is composed of a form in which the special characters which are used most commonly are provided at the right and left of the alphabet part (37), and less common special characters are provided at a greater distance from the alphabet part (37).

33. The input device according to one of the preceding claims, characterized in that the character set (27) is constructed in a form in which the sequence of the letters in each column in the alphabet part (37) runs from top to bottom, with the first letter in the alphabet being arranged at the upper left.

34. The input device according to one of the preceding claims, characterized in that an orientation bar (33) is imaged parallel to the character set (27) on the display screen (23), representing symbolically the total length of the character set (27) on which a movable marker (35) indicates the instantaneous position of the alphabet part (37) in the character set (27).

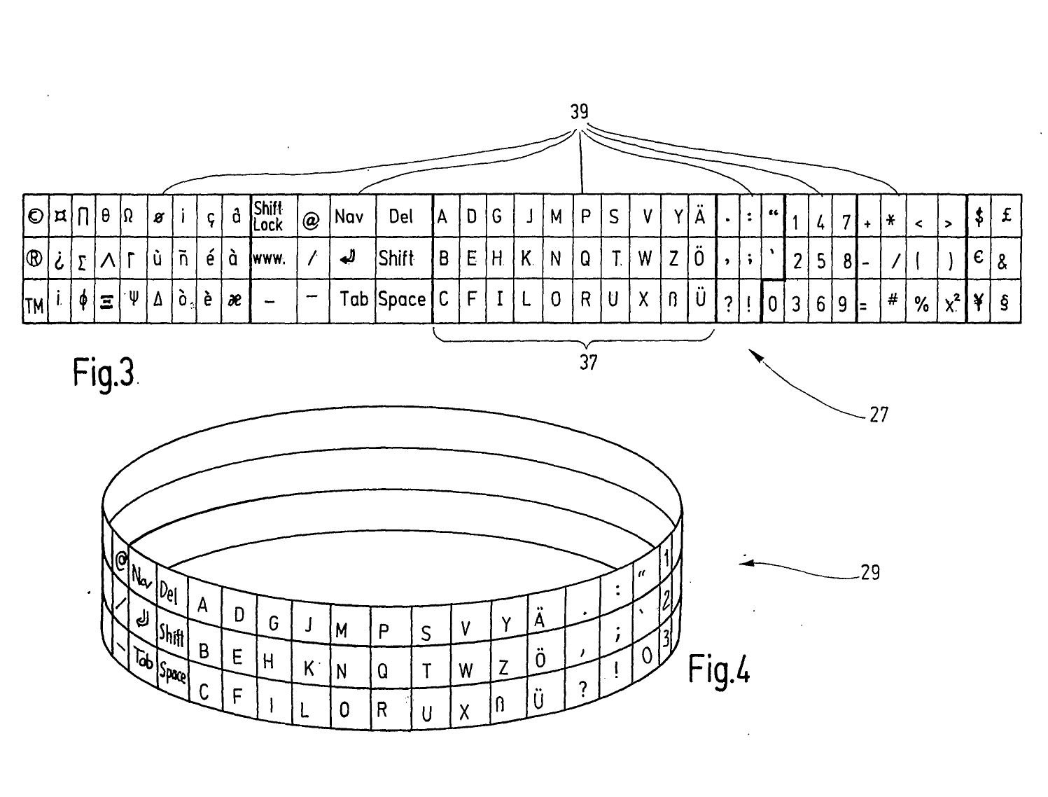

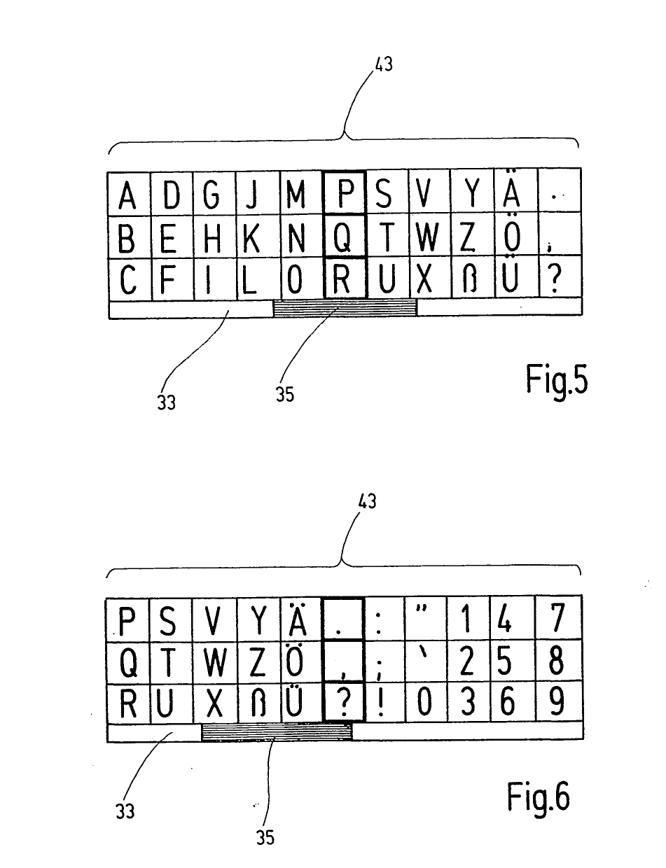

35. The input device according to one of the preceding claims, characterized in that the character (27) according to FIG. 3 is used.

36. The input device according to one of the preceding claims, characterized in that the scrolling device (17) has at least one scrolling edge (19), at least one sensor strip, at least one touchpad and/or at least one rocker button.

37. The input device according to one of the preceding claims, characterized in that the scrolling wheel (19) is designed as a pushbutton.

38. The input device according to one of the preceding claims, characterized by a displaceable axis relative to the rotationally movable bearing of the scrolling wheel (19).

39. The input device according to one of the preceding claims, characterized in that the scrolling wheel can be turned in and preferably also against the direction of travel of the vehicle when traveling forward, with the arrangement of the scrolling wheel on the operating element, in particular the steering wheel, preferably being such that with conventional handling of the operating element, the thumb of the hand comes to rest on the scrolling wheel.

40. The input device according to one of the preceding claims, characterized by at least one pressure sensor in the area of the suspension of the axle.

41. The input device according to one of the preceding claims, characterized in that the pressure sensor is arranged in the area of the outer surface of the scrolling wheel (19).

42. The input device according to one of the preceding claims, characterized in that the scrolling wheel (19) is interchangeable and may be designed in various versions to permit different transmission ratios for the scrolling function.

43. The input device according to one of the preceding claims, characterized in that the pushbuttons (21A, 211B, 21C) and/or the additional buttons are designed as sensor buttons.

44. The input device according to one of the preceding claims, characterized in that the input elements (19, 21A, 21B, 21C) required for input of characters of the character set (27) are also designed in duplicate in mirror symmetry for right-handed and left-handed operation.

45. The input device according to one of the preceding claims, characterized in that the display screen (23) and a selection and input unit comprising at least the scrolling device (17) are arranged in spatially separate areas.

46. The input device according to one of the preceding claims, characterized in that the vehicle is a land vehicle, in particular a motor vehicle or a truck, a watercraft or an aircraft, in particular an airplane, a helicopter or a spacecraft.

47. A method of input of characters from a set of characters into an input device in a motor vehicle having at least one scrolling device and at least one pushbutton, wherein at least a portion of the character set is displayed by rows and columns on a display screen, in particular according to one of claims 1 through 46, characterized in that the input of a character is performed by means of a scrolling device which preselects a portion of a column or an entire column and by means of the at least one pushbutton by means of which a character is selected from the row of the preselected column.
